(19) United States
(12) Patent Application Publication
(10) Pub. No.: US 2021/0369430 A1
(43) Pub. Date: Dec. 2, 2021

(54) HANDS FREE, ARTICULABLE DENTAL SUCTION DEVICE

(71) Applicant: AEMS DENTAL AEROSOL MANAGEMENT AND MITIGATION SYSTEM LLC, Ann Arbor, MI (US)

(72) Inventors: Michael J. Paquette, Northville, MI (US); Mert N. Aksu, Ann Arbor, MI (US)

(21) Appl. No.: 17/332,253

(22) Filed: May 27, 2021

Related U.S. Application Data
(60) Provisional application No. 63/031,293, filed on May 28, 2020.

(51) Int. Cl. A61C 17/12; A61C 17/08

(52) U.S. Cl. CPC A61C 17/125; A61C 17/08

(57) ABSTRACT

A hands free suction device configured to remove matter generated during a dental procedure on a patient. The device includes a hose including a suction end, a connection end configured to be connected to a dental suction system, and a hollow fluid flow passageway extending between the suction end and the connection end. The hollow fluid flow passageway is configured to pass evacuated matter from the suction end to the connection end. The device also includes a nozzle that is coupled to the suction end of the hose and adapted to be disposed outside of an oral cavity of the patient. A first portion of the hose is articulable relative to a second portion of the hose, such that a dental professional performing the dental procedure does not need to hold the device during the dental procedure but can easily reposition the device if needed.

### FIELD OF THE DISCLOSURE

The present disclosure generally relates to a dental suction device and, more particularly, to a hands free, magnetically mounted, articulable extraoral dental suction device that reduces the dispersion of infectious dental aerosols generated during a dental procedure without interfering with performance of the dental procedure.

### BACKGROUND

Dental professionals (e.g., dentists and dental hygienists) employ all kinds of dental tools (e.g., handpieces and ultrasonic units) when performing a dental procedure in an oral cavity of a patient in an examination room. These dental tools produce aerosols and splatter that are often expelled from the oral cavity and may contain saliva, blood, bacteria, pathogens, and other matter. Aerosols can linger in the air in the examination room for some time (and may migrate into the HVAC system) while splatter may land on the dental professional, the dental tools, other dental equipment (e.g., the dental chair), or any other object or person in the vicinity of the patient, thereby increasing the risk that bacteria and viruses (e.g., influenza, herpes, SARS, Covid-19) will be spread to the dental professional and/or other people (e.g., other personnel, other patients).

It is therefore desirable to control, or at least mitigate (as much as possible), the expulsion of aerosols and splatter from the oral cavity of the patient during a dental procedure. In some cases, dental professionals may employ a suction tool, such as a high volume evacuator device, a saliva ejector device, or an isolation device, for this purpose. These suction tools are positioned in the oral cavity of the patient during the dental procedure and utilize negative pressure to help transfer matter that would otherwise be expelled from the oral cavity to another location. In other cases, dental professionals may employ a mouthpiece such as the Isolight or DryShield product for this purpose. These mouthpieces are fixedly but removably positioned in a posterior quadrant of the oral cavity of the patient subject to the dental procedure, and, so positioned, the mouthpieces block or substantially prevent the expulsion of aerosols and splatter from that quadrant of the oral cavity of the patient.

There are, however, numerous problems with these known devices. The dental professional, for example, must hold known suction tools in the oral cavity of the patient while in operation. This, in turn, places that dental professional (and/or other personnel) within or in very close proximity to the oral cavity of the patient, thereby exposing the dental professional (and/or other personnel) to the matter generated in the oral cavity and any matter expelled from the oral cavity and not captured by the suction tool. The dental professional must also hold known suction tools in place while simultaneously holding the other dental equipment (e.g., handpieces and ultrasonic units) needed to actually perform the dental procedure, which is not only difficult to do but can slow down or otherwise interfere with the performance of the dental procedure. Known mouthpieces, meanwhile, need not be held in place, but they must frequently be repositioned within the oral cavity during the dental procedure (in order to allow the dental procedure to be performed), forcing the dental professional to stop the procedure, remove the mouthpiece, and reposition the mouthpiece in the desired location. Moreover, because mouthpieces are positioned in the posterior quadrant of the oral cavity, they tend to be rather ineffective in blocking or preventing the expulsion of aerosols and splatter generated by the anterior of the oral cavity of the patient, for example when the dental procedure is performed in connection with anterior teeth.

### SUMMARY

One aspect of the present disclosure includes a hands free suction device configured to remove matter generated during a dental procedure on a patient. The device includes an articulable hose including a suction end, a connection end configured to be connected to a dental suction system, and a hollow fluid flow passageway extending between the suction end and the connection end. The hollow fluid flow passageway is configured to pass evacuated matter from the suction end to the connection end. The device also includes a nozzle that is coupled to the suction end of the hose and adapted to be disposed outside of an oral cavity of the patient. A first portion of the hose is articulable relative to a second portion of the hose.

Another aspect of the present disclosure includes a hands free suction device configured to remove matter generated during a dental procedure on a patient. The device includes a hose including a suction end, a connection end, and a hollow fluid flow passageway extending between the suction end and the connection end and configured to pass evacuated matter from the suction end to the connection end. The connection end is configured to be connected to the dental suction system. The device also includes a nozzle coupled to the suction end of the hose, the nozzle adapted to be disposed outside of an oral cavity of the patient, and a mounting element coupled to a portion of the hose. The hose is articulable relative to the mounting element.

Another aspect of the present disclosure includes a hands free suction device configured to remove matter generated during a dental procedure on a patient. The device includes a hose including a suction end, a connection end, and a fluid flow passageway extending between the suction end and the connection end and configured to pass evacuated particles from the suction end to the connection end, the connection end configured to be connected to the dental suction system. The device also includes a nozzle coupled to the suction end of the hose, the nozzle adapted to be disposed outside of an oral cavity of the patient. A first portion of the hose is articulable relative to a second portion of the hose to reach a desired position for the dental procedure, and the hose is constructed to retain the first portion of the hose in the desired position.

Additional optional aspects, arrangements, examples, and features are disclosed, which may be arranged in any functionally appropriate manner, either alone or in any functionally viable combination, consistent with the teachings of the disclosure. Other aspects and advantages will become apparent upon consideration of the following detailed description.

### BRIEF DESCRIPTION OF THE DRAWINGS

The features of this disclosure which are believed to be novel are set forth with particularity in the appended claims. The present disclosure may be best understood by reference to the following description taken in conjunction with the accompanying drawings, in which like reference numerals identify like elements in the several figures, in which:

FIG. 1 illustrates one example of a dental suction tool constructed in accordance with the teachings of the present disclosure; and

FIG. 2 illustrates another example of a dental suction tool constructed in accordance with the teachings of the present disclosure.

### DETAILED DESCRIPTION

The present disclosure is directed to a dental device that aims to solve the above-discussed problems as well as other problems with these known devices or other devices. The dental device disclosed herein improves hygiene by mitigating the expulsion of infectious aerosols (e.g., low molecular weight aerosols) and splatter from an oral cavity of a patient during a dental procedure in an examination room, but does so without interfering with the performance of that dental procedure. More particularly, the dental device is a suction device that is configured to be connected to a dental suction system (either in the examination room or outside of the examination room) and is positionable immediately adjacent to but outside of the oral cavity for capturing and evacuating matter generated in the oral cavity during the dental procedure, thereby providing the dental professional with full, uninhibited access to the oral cavity and limiting or reducing the exposure of the dental professional to the oral cavity itself. At the same time, the dental device is a hands free, articulable suction device, such that the dental professional does not need to hold the dental device during the dental procedure but can easily reposition the dental device if needed. Additionally the dental device is effective in reducing the exhaled nitrous oxide contamination from exhaled air during dental procedures when nitrous oxide is administered as a sedative agent. Nitrous oxide is an environmental concern, and because the device is connected to the dental suction system, the evacuation of harmful gasses does not result in recirculation in the examination room.

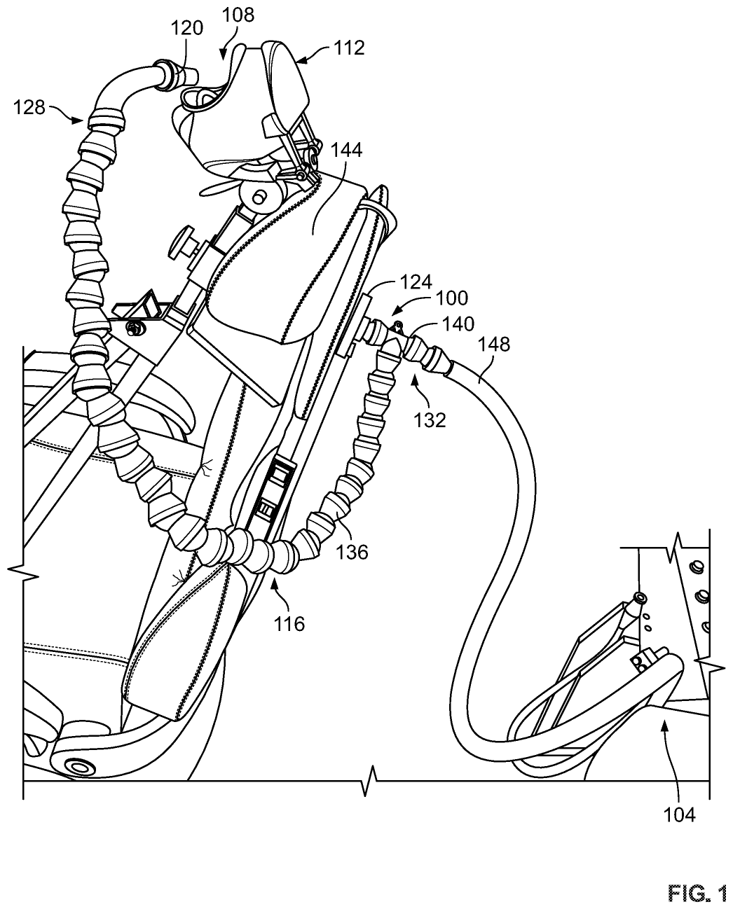

FIG. 1 illustrates one example of a hands free suction device 100 constructed in accordance with the teachings of the present disclosure. The hands free suction device 100 is configured to be connected to a dental suction system such as the dental suction system 104, which in this example is positioned in the same examination room as the hands free suction device 100 (but need not be). The hands free suction device 100 is positionable immediately adjacent to but outside of an oral cavity 108 of a patient (FIG. 1 illustrates a portion of a fake patient 112). So positioned, the hands free suction device 100 is configured to remove matter (e.g., pathogens, bacteria) generated in the oral cavity 108 during a dental procedure, e.g., a cleaning, a root canal, a filling, teeth whitening, an extraction, or the like, performed in the oral cavity 108. In turn, the hands free suction device 100 passes the removed matter back to the dental suction system 104, which in turn discards the removed matter. At the same time, because the hands free suction device 100 works outside the oral cavity 108, the hands free suction device 100 does not interfere with the operation of the performance of the dental procedure.

As illustrated in FIG. 1, the hands free suction device 100 generally includes a hose 116. The hose 116 includes a suction end 128, a connection end 132 opposite the suction end, and a hollow fluid flow passageway 136 that extends between the suction end 128 and the connection end 132. The connection end 132 is configured to be connected to the dental suction system 104. In the illustrated example, the connection end 132 is connected to the dental suction system 104 via an adapter 140 that connects the connection end 132 to a hose 148 of the dental suction system 104. In other examples, however, the connection end 132 can be directly connected to the dental suction system 104 (i.e., without the adapter 140) or may be indirectly connected to the dental suction system 104 in a different manner (e.g., using a different adapter). In any event, when the connection end 132 is connected to the dental suction system 104, the hose 116 itself functions as an evacuator (e.g., a high volume evacuator) that evacuates the matter generated in the oral cavity. Thus, the hose 116 does not include (and there is no need for) a separate evacuator (e.g., a high volume evacuator) or other suction tool to be disposed within (e.g., sleeved by) the hose 116 (and, more particularly, the hollow fluid flow passageway 136). Indeed, in many cases, disposing a separate evacuator or other suction tool within the fluid flow passageway 136 would only serve to negatively affect the ability of the hose 116 to evacuate the matter generated in the oral cavity.

As also illustrated in FIG. 1, the hands free suction device 100 also generally includes a nozzle 120 coupled to the hose 116 and a mounting element 124 coupled to the hose 116. The nozzle 120 is generally configured to fluidly couple the oral cavity 108 with the fluid flow passageway 136, but, as discussed above, does so at a position outside of the oral cavity 108. In some examples, the nozzle 120 is positionable approximately 1″ from a portion of the lips of the oral cavity 108. In other examples, the nozzle 120 can be positioned closer to or further from the lips of the oral cavity 108 or another portion of the oral cavity 108. In the illustrated example, the nozzle 120 is fixedly coupled to (e.g., integrally formed with) the suction end 128, though in other examples, the nozzle 120 can be removably coupled to the suction end 128 or fixedly or removably coupled to another portion of the hose 116. The nozzle 120 is preferably sized to (at least partially) receive and retain a suction tip (not shown) in order to enhance the removal of the matter generated in the oral cavity 108. In some examples, the nozzle 120 can be specifically manufactured with an opening that is sized to (at least partially) receive and retain the suction tip therein. In other examples, however, the nozzle 120 may be modified (e.g., heated or cooled) after manufacture to expand or contract the opening so the opening is sized (to at least partially) receive and retain the suction tip therein.

Meanwhile, the mounting element 124 is generally configured to fixedly or removably mount the hose 116 (and more generally the hands free suction device 100) to an object in the examination room, e.g., a dental chair 144. In the illustrated example, the mounting element 124 includes one or more magnets configured to magnetically react with one or more magnets of the object, such that the hose 116 is removably mountable to the object (e.g., the dental chair 144).

In other examples, however, the mounting element 124 can include a different mounting means for removably mounting the hose 116 to the dental chair 144 or a different object. For example, the mounting element 124 can instead include a mechanical connection (e.g., a snap fit connection, a Velcro connection) that facilitates the removable mounting to the object. In yet other examples, the mounting element 124 can include adhesive, a mechanical connection, and/or other mounting means so that the hose 116 can be fixedly mounted within the examination room. Further, in the illustrated example, the mounting element 124 is coupled to a portion of the hose 116 at or proximate the connection end 132. In other examples, however, the mounting element 124 can be coupled to a different portion of the hose 116.

The hose 116 is constructed so that the hose 116 can be easily and quickly positionable by the dental professional (or other personnel) in a desired position for the dental procedure, and, if necessary, can be easily and quickly moved by the dental professional (or other personnel) to a different desired position during the dental procedure, all without, for example, requiring the dental professional to set down the dental tools he or she is using or going to use to perform the dental procedure. In this example, the hose 116 is made of a resilient material and formed of a plurality of segments that are articulable relative to one another, such that the hose 116 is fully articulable (i.e., is freely articulable in six degrees of freedom, including X, Y, and Z translational positions and pitch, roll, and yaw orientations). Thus, in this example, a first portion of the hose 116 (e.g., the suction end 128) is fully articulable relative to a second portion of the hose 116 (e.g., the connection end 132). Alternatively or additionally, the hose 116 may be defined as being fully articulable relative to the nozzle 120, the mounting element 124, the dental suction system 104, or combinations thereof. At the same, the hose 116 is constructed so that once the hose 116 is in a desired position or is moved to a different desired position, the hose 116 is retained or held in that desired position. More particularly, in this example, the resilient material and the shape and arrangement of the plurality of segments of the hose 116 serve to retain or hold the hose 116 in the desired position without, for example, an external force being applied to the hose 116 (e.g., the dental professional holding the hose 116) or a biasing or rigid element disposed in the hose 116. Thus, for example, when a first portion of the hose 116 (e.g., the suction end 128) is moved relative to a second portion of the hose 116 to reach a desired position, the first portion of the hose 116 is automatically held or retained in this desired position.

In some examples, the hands free suction device 100 may include any number of additional components not explicitly illustrated in FIG. 1. In one example, the hands free suction device 100 may include a sleeve, a bag, or the like that partially or fully surrounds the hose 116 and is easier to disinfect than the hose 116 itself. In another example, the hands free suction device 100 may include a sleeve, a bag, or the like that is partially or fully disposed around the hose 116 during the dental procedure but may be disposed after each dental procedure is performed.

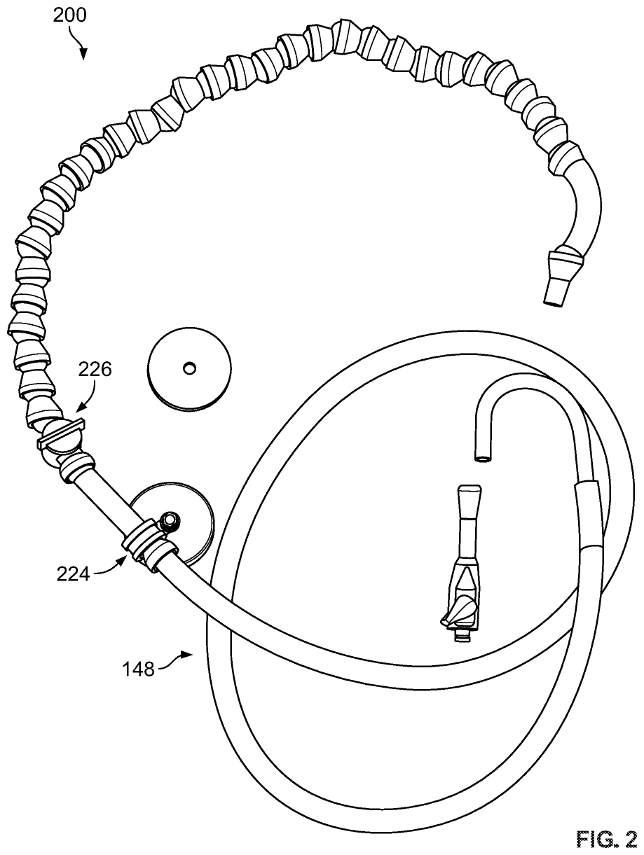

FIG. 2 illustrates another example of a hands free suction device 200 constructed in accordance with the teachings of the present disclosure. The hands free suction device 200 is substantially similar to the hands free suction device 100 but is different in two ways. First, while the hands free suction device 200 includes a mounting element 224 that also includes one or more magnets, those magnets are coupled to the hose 116 in a different manner (e.g., via a different adapter) than in the hands free suction device 100. Second, unlike the hands free suction device 100, the hands free suction device 200 includes a valve 226 that allows the dental professional (and/or other personnel) to selectively open or close the hands free suction device 200 to allow or prevent fluid flow through the hollow fluid flow passageway 136. Those skilled in the art will recognize that a wide variety of modifications, alterations, and combinations can be made with respect to the above described embodiments without departing from the scope of the disclosure, and that such modifications, alterations, and combinations are to be viewed as being within the ambit of the inventive concept.

1. A hands free suction device for connection to a dental suction system, the suction device configured to remove matter generated during a dental procedure on a patient, the suction device comprising:
a hose comprising a suction end, a connection end, and a hollow fluid flow passageway extending between the suction end and the connection end and configured to pass evacuated matter from the suction end to the connection end, the connection end configured to be connected to the dental suction system;
a nozzle coupled to the suction end of the hose, the nozzle adapted to be disposed outside of an oral cavity of the patient, and
a mounting element coupled to a portion of the hose,
wherein the hose is articulable relative to the mounting element.

2. The hands free suction device of claim 1, wherein the hose is fully articulable.

3. The hands free suction device of claim 1, wherein the hose is articulable relative to the mounting element in six degrees of freedom.

4. The hands free suction device of claim 1, wherein the hose is articulable between a first position disposed outside of the oral cavity and a second position disposed outside of the oral cavity.

5. The hands free suction device of claim 1, further comprising a suction tip carried by the nozzle.

6. The hands free suction device of claim 1, further comprising a valve coupled to the hose to selectively allow or prevent fluid flow through the hollow fluid flow passageway.

7. The hands free suction device of claim 1, wherein the mounting element comprises one or more magnets.

8. A hands free suction device for connection to a dental suction system, the suction device configured to remove matter generated during a dental procedure on a patient, the suction device comprising:
a hose comprising a suction end, a connection end, and a hollow fluid flow passageway extending between the suction end and the connection end and configured to pass evacuated matter from the suction end to the connection end, the connection end configured to be connected to the dental suction system; and
a nozzle coupled to the suction end of the hose, the nozzle adapted to be disposed outside of an oral cavity of the patient,
wherein a first portion of the hose is articulable relative to a second portion of the hose.

9. The hands free suction device of claim 8, wherein the hose is fully articulable.

10. The hands free suction device of claim 8, wherein the first portion of the hose is articulable relative to the second portion of the hose in six degrees of freedom.

11. The hands free suction device of claim 8, wherein the hose is articulable between a first position disposed outside of the oral cavity and a second position disposed outside of the oral cavity.

12. The hands free suction device of claim 8, further comprising a suction tip carried by the nozzle.

13. The hands free suction device of claim 8, further comprising a mounting element coupled to a portion of the hose, the mounting element configured to mount the hose to an object associated with the dental procedure.

14. A hands free suction device for connection to a dental suction system, the suction device configured to remove matter generated during a dental procedure on a patient, the suction device comprising:
a hose comprising a suction end, a connection end, and a hollow fluid flow passageway extending between the suction end and the connection end and configured to pass evacuated particles from the suction end to the connection end, the connection end configured to be connected to the dental suction system; and
a nozzle coupled to the suction end of the hose, the nozzle adapted to be disposed outside of an oral cavity of the patient,
wherein a first portion of the hose is articulable relative to a second portion of the hose to reach a desired position for the dental procedure, and
wherein the hose is constructed to retain the first portion of the hose in the desired position.

15. The hands free suction device of claim 14, wherein the hose is fully articulable.

16. The hands free suction device of claim 14, wherein the first portion of the hose is articulable relative to the second portion of the hose in six degrees of freedom.

17. The hands free suction device of claim 14, wherein the hose is articulable between a first position disposed outside of the oral cavity and a second position disposed outside of the oral cavity.

18. The hands free suction device of claim 14, further comprising a suction tip carried by the nozzle.

19. A method of removing particles generated during a dental procedure on a patient, the method comprising:
providing a suction device comprising a hose and a nozzle, the hose comprising a suction end, a connection end, and a hollow fluid flow passageway extending between the suction end and the connection end, and the nozzle coupled to the suction end of the hose;
connecting the connection end of the hose to a dental suction system;
positioning the nozzle adjacent to but outside of an oral cavity of the patient; and
creating a negative pressure in the hose via the dental suction system, thereby evacuating particles from the oral cavity of the patient and passing the evacuated matter from the suction end to the connection end via the hollow fluid flow passageway,
wherein a first portion of the hose is articulable relative to a second portion of the hose.

20. A method of removing matter generated during a dental procedure on a patient, the method comprising:
providing a suction device comprising a hose and a nozzle, the hose comprising a suction end, a connection end, and a hollow fluid flow passageway extending between the suction end and the connection end, and the nozzle coupled to the suction end of the hose;
connecting the connection end of the hose to a dental suction system;
positioning the nozzle adjacent to but outside of an oral cavity of the patient; and
creating a negative pressure in the hose via the dental suction system, thereby evacuating particles from the oral cavity of the patient and passing the evacuated matter from the suction end to the connection end via the hollow fluid flow passageway,
wherein a first portion of the hose is articulable relative to a second portion of the hose, and
wherein the hose is constructed to retain the first portion of the hose in the desired position.
